(19) United States
(12) Patent Application Publication
(10) Pub. No.: US 2010/0195978 A1
(43) Pub. Date: Aug. 5, 2010

(54) System to facilitate replay of multiple recordings of a live event

(76) Inventors: Gregory J. Ekchian, Belmont, MA (US); Jack A. Ekchian, Belmont, MA (US)

Correspondence Address: Dr Jack A. Ekchian, PO Box 429, Belmont, MA, 02478, US

(21) Appl. No.: 12/658,186

(22) Filed: Feb. 3, 2010

Related U.S. Application Data
(60) Provisional application No. 61/206,707, filed on Feb. 3, 2009.

(51) Int. Cl. H04N 5/95; H04N 5/91

(52) U.S. Cl. 386/85; 386/108

(57) ABSTRACT

A system is disclosed for the replay of multiple simultaneously recorded recordings of live events. Flags are used to map the time of occurrence of incidents observed on one video recording onto second simultaneously obtained recording where they can be observed. The proper phasing of mapped incidents and incidents that are explicitly visible on the second recording is maintained.

### CROSS-REFERENCE TO RELATED APPLICATIONS

This application claims priority of U.S. Provisional Patent Application No. 61/206,707, entitled “System to facilitate replay of multiple recordings of a live event”, filed Feb. 3, 2009, which is hereby incorporated by reference in its entirety.

### BACKGROUND OF INVENTION

The invention relates to the use of multiple concurrently obtained video recordings of a live event for inspection of key occurrences during replay. Certain aspects of the process for selecting, synchronizing, and viewing segments containing such occurrences during replay are automated.

The use of instant replay during broadcasts of live events, especially in slow motion, has gained increasing popularity over the last few decades. It is believed to add to the enjoyment and appreciation of many such televised events such as professional sports. More recently, instant replay has also become an integral part of the officiating process in some sports leagues. It is used to assist officials in making or reviewing calls. Nowhere has this trend been more apparent than in the National Football League (NFL). The use of instant replay for such purposes has also become more effective with the increased use of high speed digital cameras and recording devices and the increased capacity and speed of computers and digital storage equipment.

However, the use of instant replay systems as an officiating aid is still quite labor intensive, requiring extensive monitoring by technicians. For example, instant replay systems in use today by the NFL for reviewing decisions by game officials can require four or more full time dedicated technicians in the replay booth to feed multiple video recordings of an occurrence under review to an official on the field. The technicians typically present segments of several video recordings of the occurrence to a game official for review. In the NFL, the official must quickly review these and decide to uphold or overturn the decision on the field. In doing so, the official must frequently determine the order of occurrence of various key incidents. This task is frequently rendered time-consuming and difficult because it is necessary to determine the relative timing of various incidents captured on different recordings.

### BRIEF SUMMARY OF INVENTION

It is an object of the present invention to provide a video recording and replay system for processing recordings from multiple cameras. The system rapidly determines and displays the relative timing among incidents that may appear only on video recordings from different cameras. Preferably the output from each video camera, recorded by the system will include frame timing information such as timecode data and timing will be synchronized among the cameras. Alternatively, timing information may be added by the recording or replay equipment. Preferably, the timing information generated by the cameras or added by other components in the system will include data from which the absolute frame capture time (FCT) may be determined. Absolute FCT is defined as the actual time at which a particular frame is recorded by a camera. Relative timing schemes may also be used where the timing information is relative to an arbitrary baseline such as the start of the event. Preferably when relative timing is used, the baseline is the same for all the cameras so that there is no offset between relative FCT for different cameras.

The system determines the time interval between when a particular incident has occurred and the time of occurrence of another incident observed in another recording where the first incident is not discernable. An observer of the first incident during replay of a recording may flag the incident at which time the time of occurrence of that incident is recorded by the system automatically as being the FCT of the frame being displayed when the incident is flagged.

During replay of a second recording where the flagged incident may not be observable, indicators would be used to show, for example, the time interval, in seconds or other convenient units, between the flagged incident and the FCT of any frame being shown on the monitor at any given moment. Such an indicator may be a timer that is displayed. The timer may be displayed on the system display unit where the video recording is also shown. Such a timer may include times showing the interval prior to or after the time of occurrence of the flagged incident. Indicators may also utilize change of replay speeds at the time of occurrence or even freezing of the replay at the FCT of the flagged incident. Alternatively, a separate indicator may be used such as a light that may be illuminated at an intensity that is proportional to the magnitude of the interval between the FCT of the flagged incident and the FCT of the frame being displayed. Alternatively an audible indicator may be used where the pitch that is generated is proportional to the magnitude of the interval. During replay, one or more simultaneously recorded segments may be displayed at a time. Examples of the use of timecode data in various video systems is explained in U.S. Pat. No. 6,044,197, U.S. Pat. No. 6,546,190, U.S. Pat. No. 7,142,775 and U.S. Pat. No. 7,171,107 that are incorporated herein by reference in their entirety.

Using this system when a call is challenged in the course of a football game, an NFL official observing one replay video feed on a system display unit may flag one particular incident, such as the ball carrier being down by contact. This replay could be in slow motion or at normal speed. This may be achieved by using a system user interface such as a keyboard, a button, or a microphone. The FCT corresponding to the flagged incident may then be recorded and used during replay of another video record of occurrences that transpired during the period of interest. For example, the official may observe a second video record of the ball carrier fumbling the football in a recording where it is not discernable if the player was down by contact prior to the fumble. However, the system will inform the official of the instant when the player is down by comparing the FCT of the second video being displayed with the FCT flagged earlier. For example, during the playback of the second video, a timer may appear on the monitor that shows that the player was down by contact several seconds prior to the fumble. For convenience, the replay may also be frozen when the time of the flagged FCT matches the displayed FCT.

Alternatively, a flag may be set by the observer of a video showing a pitcher during a baseball game to establish the instance when the ball is released. This instance in time may be flagged during the replay of a simultaneous recording showing when the batter is starting his swing. Such a system may, for example, be used to study the reaction time of a batter to a particular pitcher, although no single video recording may show both players simultaneously with sufficient resolution.

It is a further object of this invention to mark video records in response to signals from an observer who has access to a system user interface in real time. For example, if multiple videotapes are used to record a sporting event from several vantage points, an observer watching the event or a live video feed may press a key on a keyboard every time one of several specific incidents occurs to flag the incident. Events could include, for example, a tennis player serving a ball or a football being snapped. This signal may be used by the system as a trigger to flag the multiple video recordings at the same time. Such markers may then be used, for example, to automatically cue several videotapes to be replayed from the point of the marker or with a temporal offset from the marker or to start at one marker and to stop at another. Marking of the recordings may be achieved by recording the actual time when each flag is triggered. Subsequently, during replay, the time such flags are set may be compared to the FCT of the video frame being displayed.

It is a further object of this invention to add markers or set flags automatically in response to signals from other equipment used during a live event such as the game clock or the play clock in a football game. For example, multiple video recordings of a football game may be flagged when the play clock reaches 10 seconds.

Flags may also be set automatically in response to signals from, for example, devices such as timers or sensors. If a particular flag is set automatically in real time by using an appropriate interface, the time of the flag, relative or absolute, may be obtained and stored by the system. This information may be used to control the replay of the recording or to display indicators.

It is a further object of this invention to automatically set markers or flags in response to signals from officials or other authorized observers of an event who do not have direct access to a user interface. For example, each time an official blows a whistle, an acoustics system interface may be used to set a flag.

It is a further object of this invention to incorporate markers or flags in response to, for example, sensors or monitoring equipment placed on a field, on players, or on equipment being used. For example, a motion sensor with radio communication may be used to determine when a football is snapped.

In the television broadcasting of live events today, typically multiple cameras are used to record the event from many vantage points. In a typical NFL game, there may be 20 or more cameras that continuously feed images to a control booth. To watch all such feeds simultaneously to pick out one or more segments of video that represent the best record of an incident for replay is labor intensive.

In the video monitoring system, according to the invention, an observer of the live event or a live feed may mark events of interest, such as the snap of the ball or an incomplete pass in a football game, by inserting electronic flags. The system then could queue two or more video records for review by an official or other observer to start or stop at or with a temporal offset from any of the flags inserted by the first observer.

Flags may also be inserted by participants in an event such as officials, coaches, players or other authorized participants. Markers may be initiated by acoustic, optical or electronic whistles or other handheld remote devices or by devices that are hardwired into the system.

Acoustic whistles can be detected by one or more microphones and converted to a flag. Many live events take place in extremely noisy venues. It may be necessary to isolate or enhance the acoustic signal from a whistle, so it is not masked by crowd noise, by using electronic filtering or one or more directional microphones. Acoustic whistles that are commonly used in sporting events may also be augmented so that they are more easily detected in a noisy environment. Whistles may be designed to produce, for example, optical signals or radio frequency signals in addition to or instead of the conventional acoustic signal. Alternatively the same whistle could be designed to produce two or more distinct frequencies so that its acoustic signature may be more easily detected. Examples of various types of whistles are disclosed in U.S. Pat. Nos. 4,314,316; 5,816,186; and 6,181,236 that are incorporated herein by reference in their entirety.

The markers or flags may be coded so that they may be differentiated from one another based on, for example, source, type or time initiated. For example, a special coding may be used in a football game to differentiate a flag designating the snap of the ball from a flag designating an interception. These markers may be added simultaneously to the video feed from cameras or at the recording device in real time. A processor may then be used to search for a specific type of flag to control the replay.

The flags or markers may be in various forms including, for example, magnetic stamp on videotape, a signal added to camera feeds, a visible indicator added in the field of vision of various cameras, recording of the timecode produced by cameras or recorded by recording equipment, recording other metadata in conjunction with video signals, or creating a memory map of recorded data showing location of stored video from various feeds as a function of time.

Such markers may also be added after the fact by an observer viewing a replay. For example, if it is necessary to determine if a receiver has control of the football before he steps out of bounds, an observer, such as an official, may watch one video replay that is focused on the player's feet. The observer may then initiate a marker at the point where the player steps out of bounds. The marker may then be automatically added to the records from the other camera feeds that may be queued to stop at the out of bounds marker or with a selectable time off-set from that point.

### BRIEF DESCRIPTION OF DRAWINGS

FIG. 1 shows an embodiment of a video replay system.

FIG. 2 shows a single frame from a recording of a football game.

FIG. 3 shows a single frame from a second simultaneous recording of a football game.

FIG. 4 shows a distribution of microphones for capturing sound from a whistle.

### DETAILED DESCRIPTION OF INVENTION

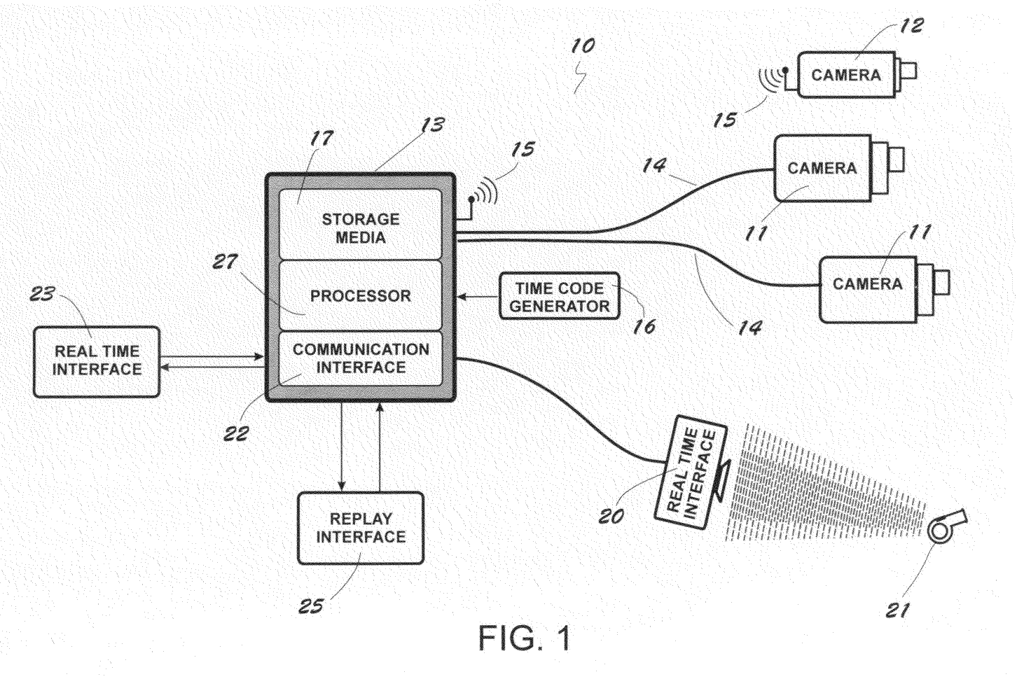

FIG. 1 depicts a video recording and replay system 10 practicing several aspects of the invention. It includes two cable connected cameras 11 and a wireless camera 12. The video images captured by the cameras are typically transferred to one or more recorders 13 by means of cables 14 or a wireless link 15. Device 13 would typically double as a video player, although physically distinct units may be used. The recording device may comprise various storage media 17 such as magnetic tape, RAM, flash memory, magnetic disc or optical disc in addition to a processor 27 and a communication interface 22. Multiple processors and interfaces may be included in such a system.

Timecode or other metadata may be added to video streams for example prior to the recorder or at the recorder by a code generator 16. Alternatively, timecode information supplied by the camera may be used. When digital storage is utilized, memory address information may be used to identify and flag locations where particular video information is stored as a function of time.

In FIG. 1, three user interfaces are shown that can be used to insert flags. Real time flags may be incorporated automatically by a whistle interface 20 that detects the acoustic signal from an official's whistle 21 and converts it to an electronic signal that is supplied to the communication interface 22 of the recorder. Interfaces may also be used that can detect optical signals or other transmissions from an official. The time when the signal is received from the interface is stored by the system. Flags may also be triggered by an observer using interface 23 watching the live action in real time. The real time interface may include a video screen and keyboard with a real time feed so the observer may watch the live video.

Flags may also be triggered by an observer who is watching a video feed during replay using the replay interface 25. The replay interface may also have a video monitor and a keyboard. A flag triggered at the replay interface may be implemented by reading the memory location of the video record being replayed and correlating that to memory locations of other recordings originally recorded at the same time. Upon receipt of the trigger, the system processor 27 may identify memory locations of one or more other records that correspond to the frame being observed. These corresponding frames may be found by calculating the memory offset of the replay flagged memory location from locations flagged in real time. The system may then be asked to replay a desired number of video records queued to start or stop at the replay flag of each record or at a temporal offset from such a flag.

Alternatively, the frame captured at the time of the video feeds may be stored for the camera feeds. Alternatively, if the cameras are synchronized, one set of FCT's from a single camera would be need to be stored.

When digital timecode information is incorporated or added, placing a flag in real time typically entails the recording of the time when signals are received from various interfaces such as interface 20. During replay, placing a flag entails reading and storing timing information. If timing data is not available, placing a flag may require data to be added to the video stream or the storage media.

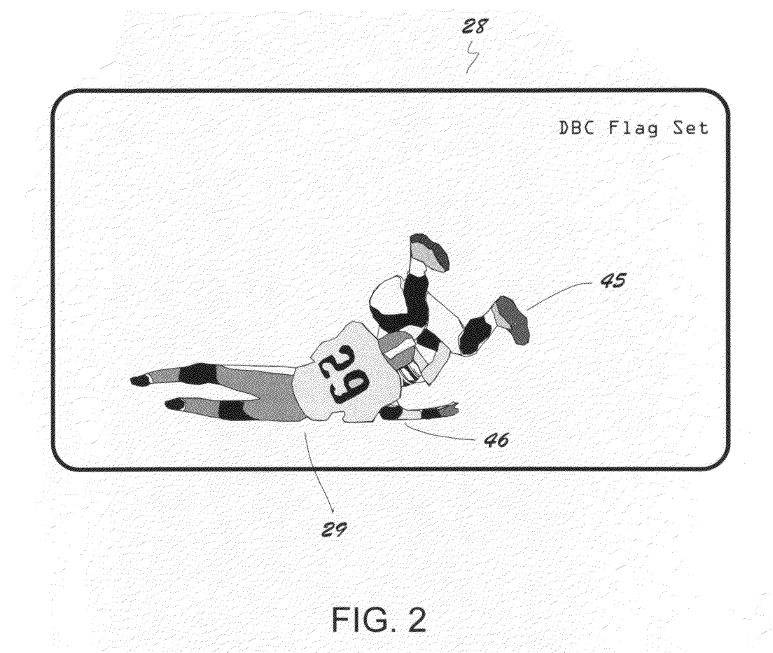

FIG. 2 shows a single frame 28 of a replay of a video recording of a football game. The defensive player 29 is tackling the ball carrier 45. The observer may determine that since the ball carrier's elbow and forearm are touching the ground, this play is down by contact. However, the ball is not visible. The observer, therefore, used a user interface to set a down by contact (DBC) flag. In response, the system looks up the CFT of the frame in FIG. 2.

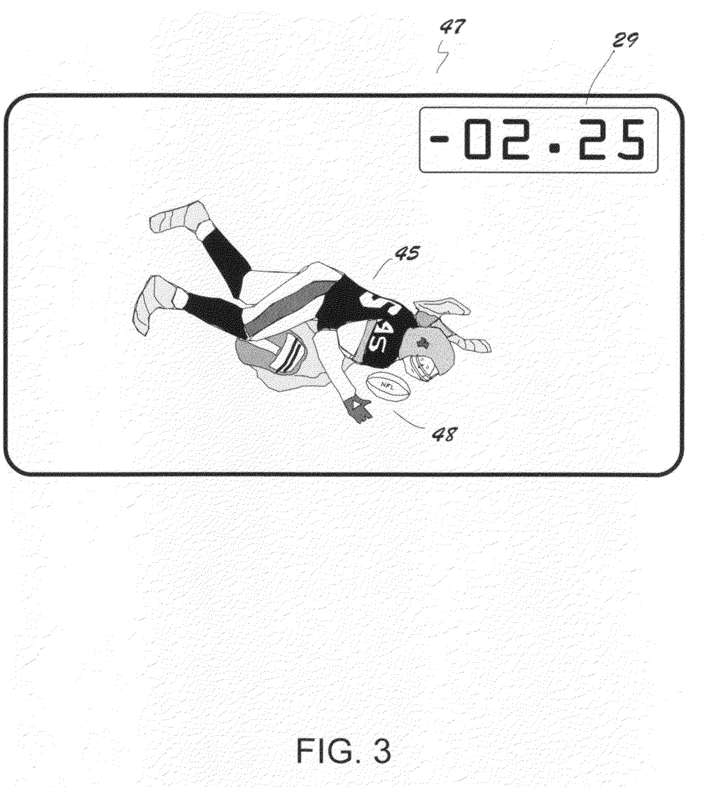

The observer then views another recording. FIG. 3 shows a frame 47 from this second recording which shows that the ball carrier 45 has fumbled the ball 48. The timer 49 displayed in the figure indicates that the CFT of this frame occurs 2.25 seconds before the CFT of FIG. 3. Therefore, the system indicates that the ball was fumbled prior to when the player was down by contact.

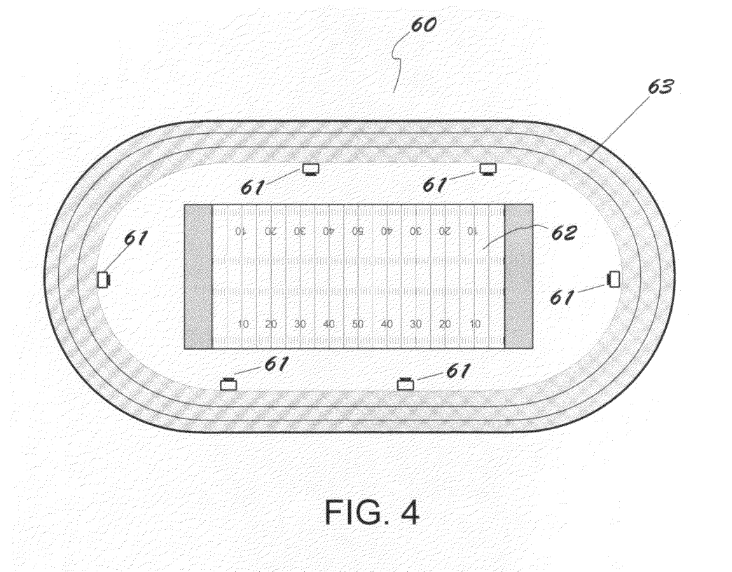

FIG. 4 shows a stadium 60 where directional microphones 61 are strategically located and directed towards the field of play 62. The noise from the spectators 63 may be diminished relative to the sound from a whistle used on the field play by the use of the directional microphones that are directed toward the field or electronic filtering of the microphone output. The filter may be a band pass filter that preferentially accepts the frequency of the whistle used by the officials. A dual frequency whistle may also be used in which case the filters used could accept the two frequencies. By using multiple microphones, it would also be possible to use triangulation to help differentiate the sound of a whistle originating on the field from one that originates in the stands.

The invention has been described in terms of its functional principles and several illustrative embodiments. Many variants of such embodiments will be obvious to those skilled in the art. Therefore, it should be understood that the ensuing claims are intended to cover all changes and modifications of the illustrative embodiments that fall within the literal scope of the claims and all equivalents thereof.

What we claim is:

1. Video recording and replay system comprising:
a recorder for concurrently recording the output from at least two video cameras, said output including timing information
a video player for playing back stored output from one of said at least two cameras and a display device for observing said output
a user interface for generating a signal by an observer watching said display device
a processor that measures the time interval between the time of capture of the frame being displayed on said display device when said signal is generated and the time of capture of any frame being displayed subsequently
a display that exhibits a measure of the extent of said time interval

2. Video recording and replay system according to claim 1 wherein said timing information comprise timecode information.

3. Video recording and replay system according to claim 2 wherein the timecode information comprise data on the absolute time of capture of each frame in recording.

4. Method of recording and replaying at least two substantially simultaneous recordings of a live event comprising,
recording the output from at least two video cameras that includes timing data
replaying and observing at least a segment of the output from one of said at least two video cameras on a monitor
obtaining the timing information corresponding to a particular incident that is observed on said monitor
determining time of occurrence of said particular incident from said timing information
replaying and observing a segment of the output from another of said at least two video cameras on a monitor
exhibiting an indicator that is a function of the time interval between the time of occurrence of said particular incident and the time of occurrence of video displayed on said monitor at any instant in time
